(19) United States
(12) Patent Application Publication
(10) Pub. No.: US 2019/0191439 A1
(43) Pub. Date: Jun. 20, 2019

(54) COMMUNICATION SYSTEM, COORDINATOR AND INTERFERENCE CONTROLLING METHOD

(71) Applicant: INDUSTRIAL TECHNOLOGY RESEARCH INSTITUTE, Hsinchu (TW)

(72) Inventors: Shih-Hao Fang, Zhubei City (TW); Jen-Yuan Hsu, Jincheng Township (TW); Jiun-You Lai, Zhudong Township (TW); Chun-Nan Liu, Taichung City (TW)

(21) Appl. No.: 15/857,112

(22) Filed: Dec. 28, 2017

(30) Foreign Application Priority Data
Dec. 14, 2017 (TW) 106143899

(51) Int. Cl. H04W 72/08; H04W 72/12; H04W 72/04

(52) U.S. Cl. CPC H04W 72/082; H04W 72/1231; H04W 88/085; H04W 72/1247; H04W 72/0446

(57) ABSTRACT

A communication system, a coordinator and an interference controlling method are provided. The communication system includes at least two user equipments, at least two remote radio heads (RRHs) and the coordinator. Each of the RRHs electrically connects a plurality of antennas. The coordinator includes a scanning unit, a storing unit and a scheduling unit. The scanning unit operates the measurement of a performance of each of the antennas used for each of the user equipments by antenna sweeping. The RRHs are classified into at least one group. The scheduling unit schedules the communication of the user equipments. At least some of the user equipments using the same one of the at least one group are scheduled in different time slots to prevent from interference.

This application claims the benefit of Taiwan application Serial No. 106143899, filed Dec. 14, 2017, the disclosure of which is incorporated by reference herein in its entirety.

### TECHNICAL FIELD

The disclosure relates in general to a communication system, a coordinator and an interference controlling method.

### BACKGROUND

In the smart antenna technology, the best antenna can be selected from a plurality of antennas for a single base station. However, in conventional, the smart antenna technology is merely adopted for single base station, and the diversity of communication is not good. Along with the increment of the amount of the antennas, the antenna array may be very huge and cannot be used in a small base station. Moreover, the multi-base station technology is tried to be adopted to increase the spectrum efficiency. However, the interference among the base stations is not successfully solved, so the multi-base station technology cannot be adopted now.

### SUMMARY

The disclosure is directed to a communication system, a coordinator and an interference controlling method.

According to one embodiment, an interference controlling method of a communication system is provided. The communication system is used for at least two user equipments to communicate. The interference controlling method includes the following steps. The measurement of a performance value of each of a plurality antennas electrically connected to each of a plurality of remote radio heads (RRHs) is operated for each of the user equipments by antenna sweeping. A performance table is obtained according to the performance value of each of the plurality of antennas. The performance table records an applicable relationship between each of the user equipments and the antennas or an applicable relationship between each of the user equipments and the RRHs. The RRHs are classified into at least one group. The user equipments are scheduled according to a priority information and the performance table. At least some of the user equipments using the same one of the at least one group are scheduled in different time slots to prevent from an interference.

According to another embodiment, a communication system is provided. The communication system includes at least two user equipments, at least two remote radio heads (RRHs) and a coordinator. Each of the RRHs is electrically connected to a plurality of antennas. The communication system is used for the user equipments to communicate. The coordinator includes a scanning unit, a storing unit and a scheduling unit. The scanning unit is used for operating measurement of a performance value of each of the antennas used for each of the user equipments by antenna sweeping, and obtaining a performance table according to the performance value of each of the plurality of antennas. The performance table records an applicable relationship between each of the user equipments and the antennas or an applicable relationship between each of the user equipments and the RRHs, and the RRHs are classified into at least one group. The storing unit is used for storing the performance table. The scheduling unit is used for scheduling the user equipments according to a priority information and the performance table. At least some of the user equipments using the same one of the at least one group are scheduled in different time slots to prevent from an interference.

According to an alternative embodiment, a coordinator is provided. The coordinator is used for coordinating a communication system. The communication system is used for at least two user equipments to communicate. The coordinator includes a scanning unit, a storing unit and a scheduling unit. The scanning unit is used for operating measurement of a performance value of each of a plurality of antennas electrically connected to each of a plurality of remote radio heads (RRHs) for each of the user equipments by antenna sweeping, and obtaining a performance table according to the performance value of each of the plurality of antennas. The performance table records an applicable relationship between each of the user equipments and the antennas or an applicable relationship between each of the user equipments and the RRHs. The RRHs are classified into at least one group. The storing unit is used for storing the performance table. The scheduling unit is used for scheduling the user equipments according to a priority information and the performance table. At least some of the user equipments using the same one of the at least one group are scheduled in different time slots to prevent from an interference.

### BRIEF DESCRIPTION OF THE DRAWINGS

FIG. 1 shows a communication system according to one embodiment.

FIGS. 2A to 2E show several examples of grouping the RRHs in the communication system.

FIG. 3 shows a block diagram of a coordinator.

FIG. 4 shows a flowchart of an interference controlling method of the communication system according to one embodiment.

FIG. 5 shows a flowchart of the interference controlling method of the communication system according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

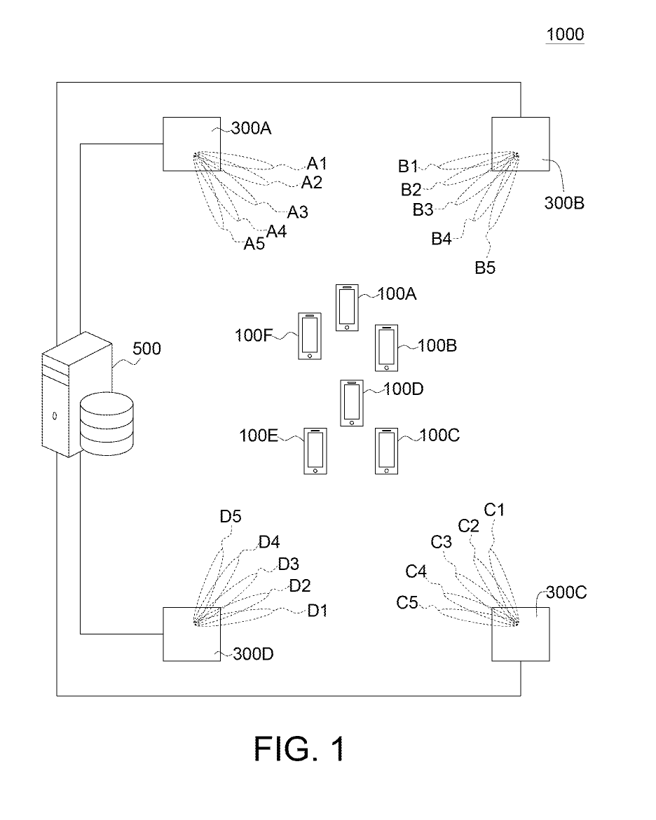

Please refer to FIG. 1, which shows a communication system 1000 according to one embodiment. The communication system 1000 includes at least two user equipments, such as the user equipments 100A to 100F, at least two remote radio heads (RRHs), such as the RRHs 300A to 300D and a coordinator 500. For example, each of the user equipments 100A to 100F may be, but not limited to, a smart phone, a laptop, a computer in vehicle, a smart TV, a robot or a smart appliance. In the present embodiment, the RRH 300A is electrically connected to a plurality of antennas A1 to A5, the RRH 300B is electrically connected to a plurality of antennas B1 to B5, the RRH 300C is electrically connected to a plurality of antennas C1 to C5, the RRH 300D is electrically connected to a plurality of antennas D1 to D5. Each of the RRHs 300A to 300D may adopt the smart antenna technology, that several antennas having different radiation directions can be disposed on a board or a pillar. One of the antennas A1 to A5, B1 to B5, C1 to C5, D1 to D5 can be used to form several beams with different directions for the user equipments 100A to 100F. The dotted line in FIG. 1 represents the beam. The antennas A1 to A5, B1 to B5, C1 to C5, D1 to D5 are disposed in the inside of the RRHs 300A to 300D. In FIG. 1, antennas A1 to A5, B1 to B5, C1 to C5, D1 to D5 are labeled on the beams. The coordinator 500 may be, but not limited to, a server, a processor, a chip, a circuit, a circuit board or a non-transitory computer readable media storing a plurality of program codes.

As shown in FIG. 1, the user equipments 100A to 100F may communicate via the RRHs 300A to 300D. The coordinator 500 is used for coordinating the operation of the RRHs 300A to 300D to prevent from the interference among the RRHs 300A to 300D, such that the communication efficiency of the communication system 1000 can be improved.

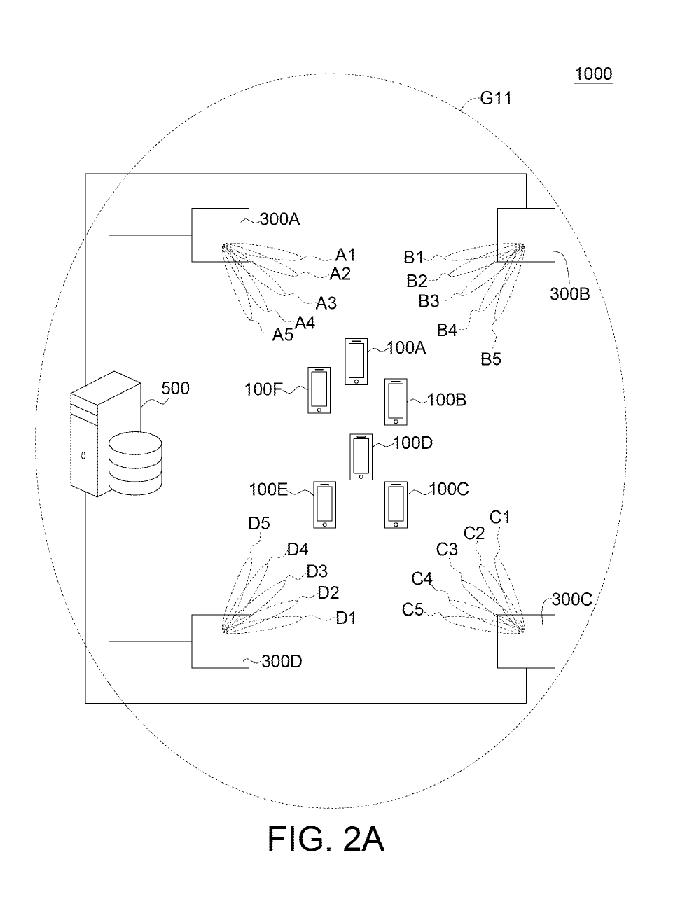

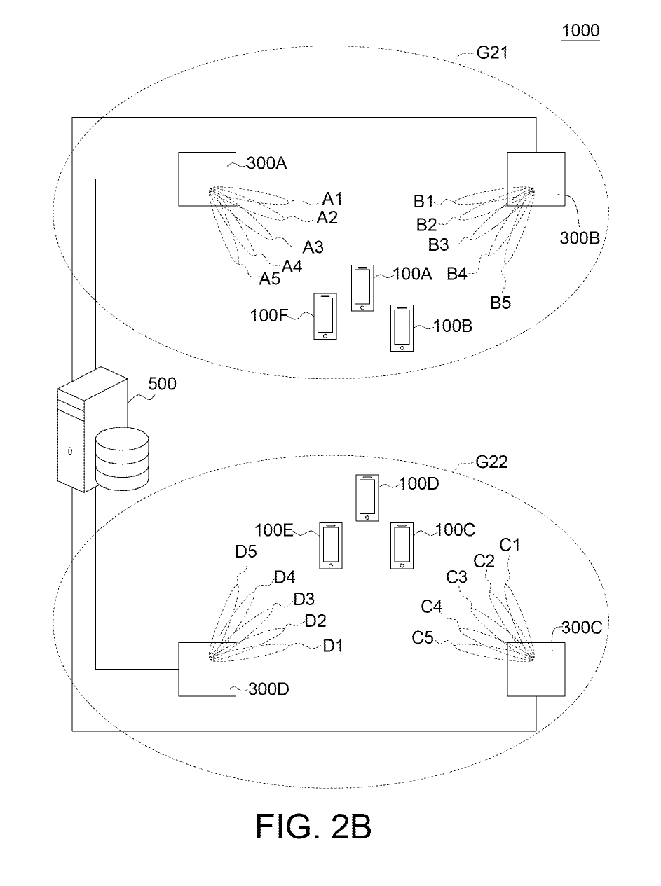

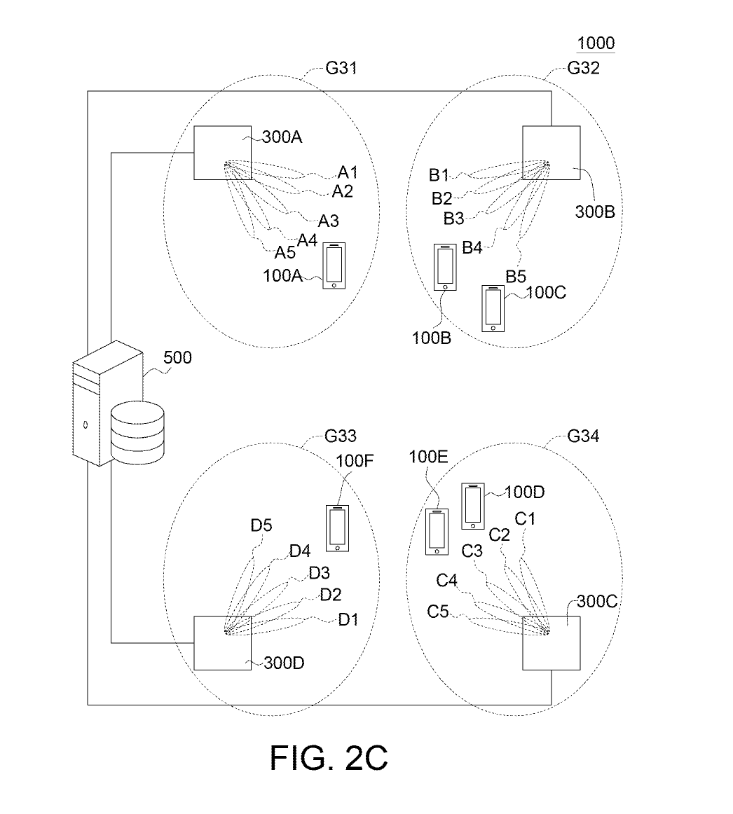

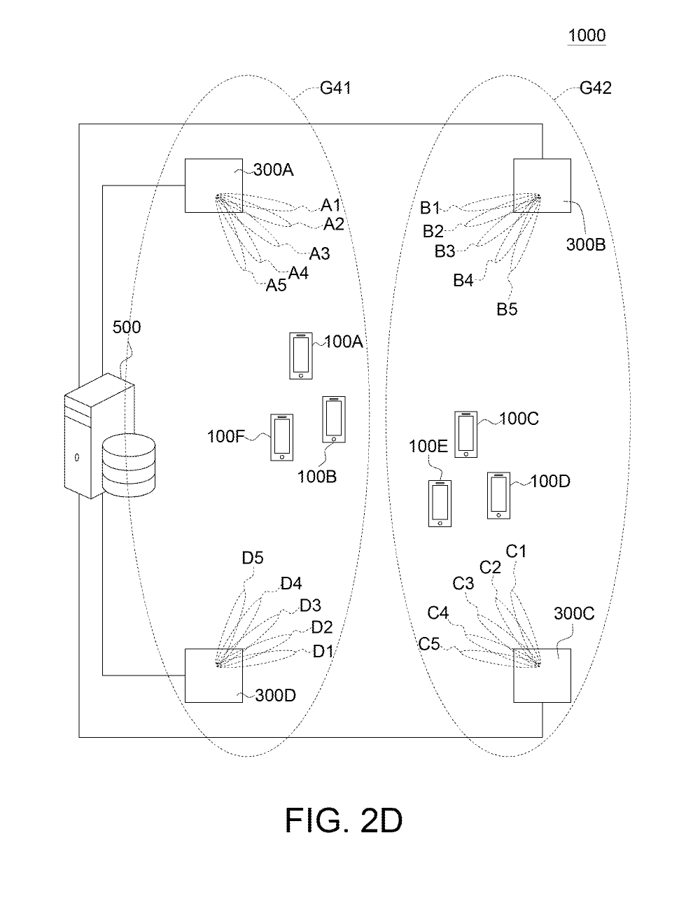

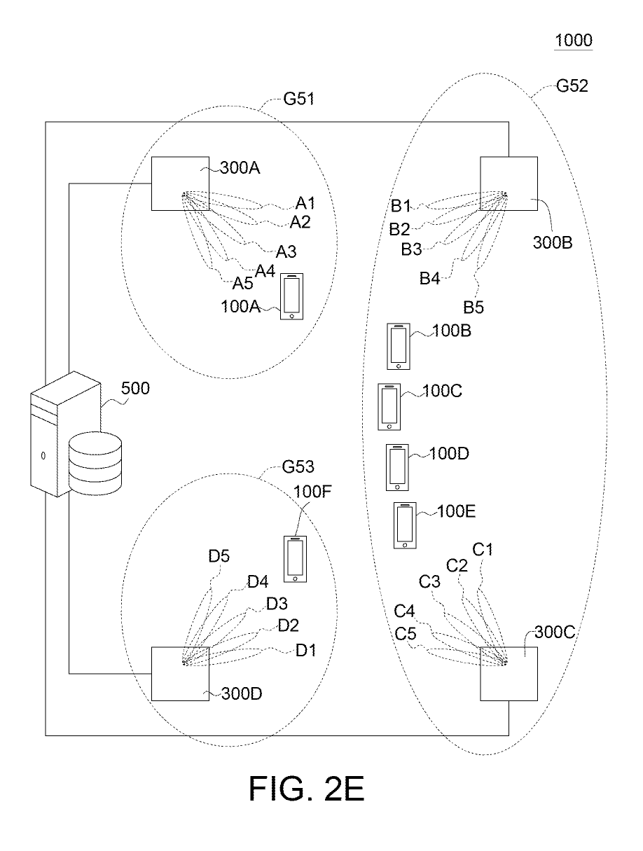

Please refer to FIGS. 2A to 2E, which show several examples of grouping the RRHs 300A to 300D in the communication system 1000. In the present embodiment, to prevent the interference among the RRHs 300A to 300D, several groupings may be selectively used for the RRHs 300A to 300D.

As shown in FIG. 2A, if the user equipments 100A to 100F served by the RRHs 300A to 300D are interfered with each other, the coordinator 500 may classify the RRHs 300A to 300D into one group G11. In one time slot, the coordinator 500 selects one or more RRHs from the RRHs 300A to 300D in the group G11 to serve one of the user equipments 100A to 100F in the group G11. That is to say, the user equipments 100A to 100F served by the RRHs 300A to 300D are not scheduled in one time slot to prevent from the interference. In this example, only one user equipment is scheduled in one time slot.

As shown in FIG. 2B, if the user equipments 100A, 100B, 100F served by the RRHs 300A, 300B are interfered with each other, the coordinator 500 may classify the RRHs 300A, 300B into a group G21. If the user equipments 100C, 100D, 100E served by the RRHs 300C, 300D are interfered with each other, the coordinator 500 may classify the RRHs 300C, 300D into a group G22. In one time slot, the coordinator 500 selects one or more RRHs from the RRHs 300A, 300B in the group G21 to serve one of the user equipments 100A, 100B, 100F in the group G21, and selects one or more RRHs from the RRHs 300C, 300D in the group G22 to serve one of the user equipments 100C, 100D, 100E in the group G22. That is to say, the user equipments 100A, 100B, 100F served by the RRHs 300A, 300B are not scheduled in one time slot to prevent from the interference, and the user equipments 100C, 100D, 100E served by the RRHs 300C, 300D are not scheduled in one time slot to prevent from the interference. In this example, two groups G21, G22 are used for communication in one time slot, so the communication efficiency is improved.

In the present embodiment, the RRHs are classified into at least one group; and all of the at least one group can be scheduled in one time slot. For example, as shown in FIG. 2B, the RRHs 300A to 300D are classified into the group G21 and the group G22. There is an interference in the group G21, and there is an interference in the group G22. There is no interference between the group G21 and the group G22. In this example, the group G21 and the group G22 can be scheduled in one time slot.

As shown in FIG. 2C, if the user equipments 100A to 100F served by the RRHs 300A to 300D are not interfered with each other, the coordinator 500 may classify the RRHs 300A to 300D into four groups G31 to G34. In the one time slot, the coordinator 500 selects the RRH 300A in the group G31 to serve the user equipment 100A in the group G31, selects the RRH 300B in the group G32 to serve one of the user equipments 100B, 100C in the group G32, selects the RRH 300C in the group G33 to serve one of the user equipments 100D, 100E in the group G33, and selects the RRH 300D in the group G34 to serve the user equipment 100F in the group G34. In this example, four groups G31 to G34 are used for communication in one time slot, so the communication efficiency is improved.

In the present embodiment, the RRHs are classified into at least one group; and all of the at least one group can be scheduled in one time slot. For example, as shown in FIG. 2C, the RRHs 300A to 300D are classified into the group G31, the group G32, the group G33 and the group G34. There is an interference in the group G31, there is an interference in the group G32, there is an interference in the group G33, and there is an interference in the group G34. There is no interference among the group G31, the group G32, the group G33 and the group G34. In this example, the group G31, the group G32, the group G33 and the group G34 can be scheduled in one time slot.

As shown in FIG. 2D, if the user equipments 100A, 100B, 100F served by the RRHs 300A, 300D are interfered with each other, the coordinator 500 may classify the RRHs 300A, 300D into a group G41. If the user equipments 100C, 100D, 100E served by the RRHs 300B, 300D are interfered with each other, the coordinator 500 may classify the RRHs 300B, 300D into a group G42. In one time slot, the coordinator 500 selects one or more RRHs from the RRHs 300A, 300D in the group G41 to serve one of the user equipments 100A, 100B, 100F in the group G41, and selects one or more RRHs from the RRHs 300B, 300C in the group G42 to serve one of the user equipments 100C, 100D, 100E in the group G42. That is to say, the user equipments 100A, 100B, 100F served by the RRHs 300A, 300D are not scheduled in one time slot to prevent from the interference, and the user equipments 100C, 100D, 100E served by the RRHs 300B, 300C are not scheduled in one time slot to prevent from the interference. In this example, two groups G41, G42 are used for communication in one time slot, so the communication efficiency is improved.

In the present embodiment, the RRHs are classified into at least one group, and all of the at least one group can be scheduled in one time slot. For example, as shown in FIG. 2D, the RRHs 300A to 300D are classified into the group G41 and the group G42. There is an interference in the group G41, and there is an interference in the group G42. There is no interference between the group G41 and the group G42. In this example, the group G41 and the group G42 can be scheduled in one time slot.

As shown in FIG. 2E, if the user equipments 100B, 100C, 100D, 100E served by the RRHs 300B, 300C are interfered with each other, the coordinator 500 may classify the RRHs 300B, 300C into a group G52. If the user equipments 100A, 100F served by the RRHs 300A, 300D are not interfered with the user equipments in the group G52, the coordinator 500 may classify the RRHs 300A, 300D into two groups G51, G53 respectively. In the one time slot, the coordinator 500 selects the RRH 300A in the group G51 to serve the user equipment 100A in the group G541, selects one or more RRHs from the RRHs 300B, 300C in the group G52 to serve one of the user equipments 100B, 100C, 100D, 100E in the group G52, and selects the RRH 300D in the group G53 to serve the user equipment 100F in the group G53. That is to say, the user equipments 100B, 100C, 100D, 100E served by the RRHs 300B, 300C are not scheduled in one time slot to prevent from the interference. In this example, three groups G51 to G53 are used for communication in one time slot, so the communication efficiency is improved.

In the present embodiment, the RRHs are classified into at least one group, and all of the at least one group can be scheduled in one time slot. For example, as shown in FIG. 2E, the RRHs 300A to 300D are classified into the group G51, the group G52 and the group G53. There is an interference in the group G51, there is an interference in the group G52, and there is an interference in the group G53. There is no interference among the group G51, the group G52 and the group G53. In this example, all of the group G51, the group G52 and the group G53 can be scheduled in one time slot, so the communication efficiency is improved.

In different time slots, the RRHs are classified by different ways according to the status of the user equipments 100A to 100F. For clearly illustrating the classifying of the RRHs 300A to 300D, the elements of the coordinator 500 and the operation thereof are illustrated as below.

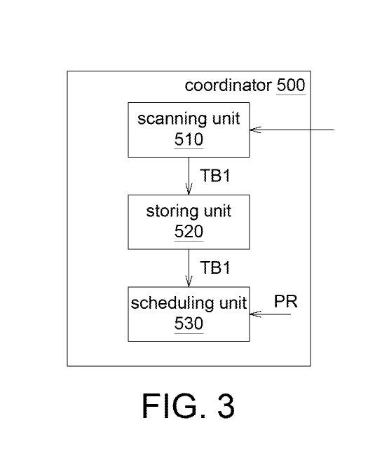

Please refer to FIG. 3, which shows a block diagram of the coordinator 500. The coordinator 500 includes a scanning unit 510, a storing unit 520 and a scheduling unit 530. The scanning unit 510 is used for obtaining the information of the antennas A1 to A5, B1 to B5, C1 to C5, D1 to D5 by antenna sweeping. For example, the scanning unit 510 may be a chip, a circuit, a circuit board or a non-transitory computer readable media storing a plurality of program codes. The storing unit 520 is used for storing information. For example, the storing unit 520 may be a memory, a hard disk or a cloud data center. The scheduling unit 530 is used for scheduling the communication. For example, the scheduling unit 530 may be a chip, a circuit, a circuit board or a non-transitory computer readable media storing a plurality of program codes. The operation of those elements is illustrated as below via a flowchart.

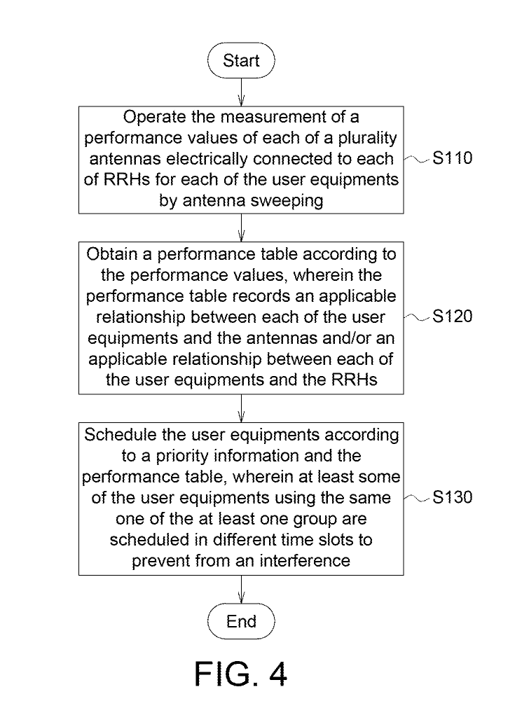

Please refer to FIG. 4, which shows a flowchart of an interference controlling method of the communication system 1000 according to one embodiment. In step S110, the scanning unit 510 operates the measurement of a performance value of each of the antennas A1 to A5, B1 to B5, C1 to C5, D1 to D5 electrically connected to the RRHs 300A to 300D used for each of the user equipments 100A to 100F by antenna sweeping.

In step S120, the scanning unit 510 creates a performance table TB1 according to the performance values. The performance table TB1 records an applicable relationship between each of the user equipments 100A to 100F and the antennas A1 to A5, B1 to B5, C1 to C5, D1 to D5 and/or an applicable relationship between each of the user equipments 100A to 100F and the RRHs 300A to 300D. The RRHs 300A to 300D are classified into at least one group.

In step S130, the scheduling unit 530 schedules the user equipments 100A to 100F according to a priority information PR and the performance table TB1, such that at least some of the user equipments 100A to 100F using the same one of the at least one group are scheduled in different time slots to prevent from the interference.

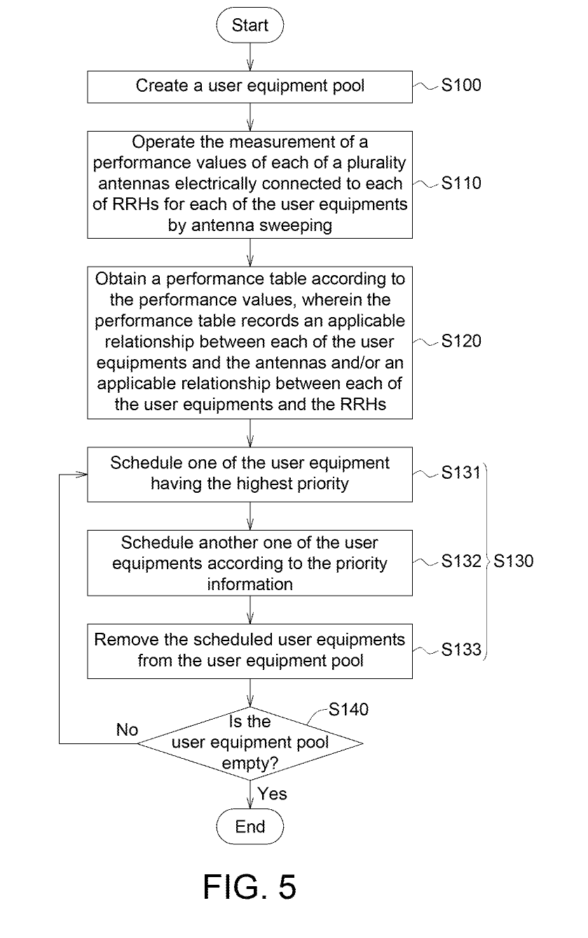

Please refer to FIG. 5, which shows a flowchart of the interference controlling method of the communication system 1000 according to another embodiment. In detail, the interference controlling method of the communication system 1000 may include more detail steps. In step S100, a user equipment pool (UE pool) is created. The user equipment pool records the user equipments 100A to 100F.

In the S110, the scanning unit 510 operates the measurement of the performance value of each of the antennas A1 to A5, B1 to B5, C1 to C5, D1 to D5 electrically connected to the RRHs 300A to 300D used for each of the user equipments 100A to 100F in the equipment pool by antenna sweeping. The scanning unit 510 may obtain the measurements via Channel Quality Indicator (CQI), Signal-to-Noise Ratio (SNR), Signal-to-Interference-plus-Noise Ratio (SINR), Received Signal Strength Indicator (RSSI), Reference Signal Received Quality (RSRQ), Reference Signal Received Power (RSRP), or Throughput.

In one embodiment, the scanning unit 510 may operate the measurement of part of the RRHs 300A to 300D for part of the user equipments 100A to 100F during the idle time. Or, in another embodiment, the scanning unit 510 may update the measurement only if the RRHs 300A to 300D change. Or, the scanning unit 510 may update the measurement only if the user equipments 100A to 100F change.

In step S120, the scanning unit 510 creates the performance table TB1 according to the performance values. The performance table TB1 records the applicable relationship between each of the user equipments 100A to 100F and the antennas A1 to A5, B1 to B5, C1 to C05, D1 to D5 and/or the applicable relationship between each of the user equipments 100A to 100F and the RRHs 300A to 300D. The performance table TB1 is stored in the storing unit 520. For example, an example of the performance table TB1 is illustrated as table I. The applicable relationship can be determined by determining whether the performance index is larger than a threshold. If the performance index of one antenna is larger than the threshold, then it is deemed that this antenna is applicable for this user equipment; if the performance index of one antenna is not larger than the threshold, then it is deemed that this antenna is not applicable for this user equipment. In table I, if one antenna is applicable for the user equipment, it is labeled “V”; if one antenna is not applicable for the user equipment, it is not labeled.

TABLE I

| remote | | user equipment | | | | | |
|---|---|---|---|---|---|---|---|
| radio | | (priority information) | | | | | |
| head | | 100A | 100B | 100C | 100D | 100E | 100F |
| (RRH) | antenna | (1) | (4) | (6) | (2) | (3) | (5) |
| 300A | A1 | V | | | | | |
| | A2 | | | | V | | |
| | A3 | | | V | | | |
| | A4 | V | V | | | | |
| | A5 | | V | | | | |
| 300B | B1 | | | V | V | | |
| | B2 | | | | V | | |
| | B3 | V | | V | | | |
| | B4 | | V | | | | |
| | B5 | | | | | | |
| 300C | C1 | | | | | | |
| | C2 | | | V | | | |
| | C3 | | | | V | V | |
| | C4 | | | | | | V |
| | C5 | | | | | V | |
| 300D | D1 | | | | | | |
| | D2 | | | V | V | | |
| | D3 | | | V | | V | V |
| | D4 | | | | | | |
| | D5 | | | | | | |

| | | | |
|---|---|---|---|
| group | group G21: | group G11: RRHs | group G22: RRH |
| | RRHs 300A, | 300A to 300D | 300C, 300D |
| | 300B | | |

One of the user equipments may use one of the antennas. Or, one of the user equipments may use more than one of the antennas. As shown in table I, the user equipment 100A uses the antennas A1, A4 connected to the RRH 300A and the antenna B3 connected to the RRH 300B. The user equipment 100B uses the antennas A4, A5 connected to the RRH 300A and the antenna B4 connected to the RRH 300B. According to the applicable relationship that the user equipment 100A and the user equipment 100B use the RRHs 300A, 300B only, the user equipments 100A, 100B and the RRHs 300A, 300B are grouped as the group G21.

The user equipment 1000 uses the antenna A3 connected to the RRH 300A, the antennas B2, B3 connected to the RRH 300B, the antenna C2 of the RRH 300C and the antennas D2, D3 connected to the RRH 300D. The user equipment 100D uses the antenna A2 of the RRH 300A, the antennas B1, B2 connected to the RRH 300B, the antenna C3 connected to the RRH 300C, and the antenna D2 connected to the RRH 300D. According to the applicable relationship that both of the user equipment 100C and the user equipment 100D use the RRH 300A to 300D, the user equipments 100C, 100D and the RRHs 300A to 300D are grouped as the group G11.

The user equipment 100E uses the antennas C3, C5 connected to the RRH 300C and the antenna D3 connected to the RRH 300D. The user equipment 100F uses the antenna C4 connected to the RRH 300C and the antenna D4 connected to the RRH 300D. According to the applicable relationship that both of the user equipment 100E and the user equipment 100F use the RRHs 300C to 300D only, the user equipments 100E, 100F and the RRHs 300C to 300D are grouped as the group G22. That is to say, in the 8120, the RRHs 300A to 300D are classified into at least one group.

In step S130, the scheduling unit 530 schedules the user equipments 100A to 100F according to the priority information PR and the performance table TB1, such that at least some of the user equipments 100A to 100F using the same one of the at least one group are scheduled in different time slots to prevent from the interference.

For example, according to the priority information PR, the user equipments 100A to 100F may be arranged as “the user equipment 100A, the user equipment 100D, the user equipment 100E, the user equipment 100B, the user equipment 100F and the user equipment 100C.” The step S130 includes steps S131 to S133. In step S131, the scheduling unit 530 first schedules the user equipment having the highest priority information PR. As shown in table II, the scheduling unit 530 schedules the user equipment 300A having the highest priority information PR to use the RRHs 300A, 300B in the first time slot.

TABLE II

| | | | | | | Fourth |
|---|---|---|---|---|---|---|
| | First time | | Second time | Third time | | time |
| | slot | | slot | slot | | slot |
| group | G21 | G22 | G11 | G21 | G22 | G11 |
| RRH | 300A, | 300C, | 300A to | 300A, | 300C, | 300A to |
| | 300B | 300D | 300D | 300B | 300D | 300D |
| Antenna | A1, A4, | C3, C5, | A2, B1, B2, | A4, A5, | C4, D4 | A3, B1, |
| | B3 | D3 | C3, D2 | B4 | | B3, C2, |
| | | | | | | D2, D3 |
| user | 100A | 100E | 100D | 100B | 100F | 100C |
| equipment | | | | | | |

In step S132, the scheduling unit 530 schedules another user equipment according to the priority information PR without any interference. As shown in table I, there is an interference between the user equipment 100D having the second highest priority information PR and the user equipment 100A for using the RRHs 300A, 300B, so the scheduling unit 530 tries to schedule the user equipment 100E having the third priority information PR. Therefore, the scheduling unit 530 schedules the user equipment 100E in the first time slot to use the RRHs 300C, 300D.

In step S133, the scheduling unit 530 removes the scheduled user equipments 100A, 100E from the user equipment pool.

In step S140, the scheduling unit 530 determines whether the user equipment pool is empty. If the user equipment pool is not empty, then the process returns to steps S131 to S133, until the user equipment pool is empty. As shown in table II, after scheduling the first time slot, the user equipments 100B, 100C, 100D, 100F may be arranged as the user equipment 100D, the user equipment 100B, the user equipment 100F, the user equipment 100C″ according to the priority information PR.

Then, the scheduling unit 530 schedules the user equipment 100D having the highest priority information PR in the second time slot to use the RRHs 300A to 3000.

The RRHs 300A to 300D are used in the second time slot, so other user equipments 100B, 100F, 100C cannot be scheduled in the second time slot.

After scheduling the second time slot, the user equipments 100B, 100C, 100F may be arranged as “the user equipment 100B, the user equipment 100F, the user equipment 100C” according to the priority information PR. Then, the scheduling unit 530 schedules the user equipment 100B having the highest priority information PR in the third time slot to use the RRHs 300A, 300B. There is no interference between the user equipment 100F having the second priority information to use the RRHs 300C, 300D and the user equipment 100B to use the RRHs 300A, 300B, so the scheduling unit 530 can schedules the user equipment 100F in the third time slot to use the RRHs 300C, 300D.

After scheduling the third time slot, the user equipment 100C is arranged according to the priority information PR. Then, the scheduling unit 530 schedules the user equipment 100C having the highest priority information in the fourth time slot to use the RRHs 300A to 300D.

Base on above, the grouping in FIG. 2B is adopted in the first time slot, and the user equipments 100A, 100E scheduled in the first time use all of the groups G21, G22 in FIG. 2B. The grouping in FIG. 2A is adopted in the second time slot, and the user equipment 100D scheduled in the second time use the group G11 in FIG. 2A. The grouping in FIG. 2B is adopted in the third time slot, and the user equipments 100B, 100F scheduled in the third time use all of the groups G21, G22 in FIG. 2B. The grouping in FIG. 2A is adopted in the fourth time slot, and the user equipment 100C scheduled in the fourth time use the group G11 in FIG. 2A. In first to fourth time slots, the RRHs 300A to 300D are classified by different ways, such as FIGS. 2A to 2E.

According to the embodiments, at least some of the user equipments 100A to 100F using the same one of the at least one group are scheduled in different time slots to prevent from the interference. For example, the user equipments 300A to 300D using the group G11 are scheduled in the first time slot, the second time slot, the fourth time slot and the third time slot respectively. The user equipments 300A, 300B using the group G21 are scheduled in the first time slot and the third time slot. The user equipments 300A, 300B using the group G22 are scheduled in the fourth time slot and the second time slot.

Besides, some of the user equipments 100A to 100F scheduled in the same time slot belong to different groups, to prevent from the interference. For example, the user equipments 100A, 100E scheduled in the first time slot belong to the different groups G21, G22. The user equipment 100D scheduled in the second time slot belongs to the group G11. The user equipments 100B, 100F scheduled in the third time slot belong to the different groups G21, G22. The user equipment 100C scheduled in the fourth time slot belongs to the group G11.

In other words, some of the user equipments 100A to 100F which are interfered with each are scheduled in different time slots. For example, the antenna A4 is applicable for the user equipment 100A and the user equipment 100B, so the user equipment 100A and the user equipment 100B cannot be scheduled in one time slot; the antenna B1 is applicable for the user equipment 100C and the user equipment 100D, so the user equipment 100C and the user equipment 100D cannot be scheduled in one time slot. On the other hand, there is no common antenna applicable for both of the user equipment 100A and the user equipment 100E, so the user equipment 100A and the user equipment 100E can be scheduled. There is no common antenna applicable for both of the user equipment 100B and the user equipment 100F, so the user equipment 100B and the user equipment 100F can be scheduled.

In the first time slot (the third time slot), the amount of the scheduled user equipments 100A, 100E (100B, 100F) is more than one. In the second time slot (the fourth time slot), the amount of the user equipment 100D (100C) is one. That is to say, in different time slots, the amounts of the scheduled user equipments are different. Besides, other kinds of grouping may be adopted in other time slots, and it depended on the status at that time slot.

According to the embodiments, the communication system 1000 may use one or more groups in one time slot, such that the spectrum efficiency can be improved. And, the communication system 1000 may adopt the grouping technology to prevent from the interference among the RRHs 300A to 300D.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An interference controlling method of a communication system, wherein the communication system is used for at least two user equipments to communicate, and the interference controlling method comprises:
operating measurement of a performance value of each of a plurality of antennas electrically connected to each of a plurality of remote radio heads (RRHs) for each of the user equipments by antenna sweeping;
obtaining a performance table according to the performance value of each of the plurality of antennas, wherein the performance table records an applicable relationship between each of the user equipments and the antennas or an applicable relationship between each of the user equipments and the RRHs, and the RRHs are classified into at least one group; and
scheduling the user equipments according to a priority information and the performance table,
wherein at least some of the user equipments using the same one of the at least one group are scheduled in different time slots to prevent from an interference.

2. The interference controlling method of the communication system according to claim 1, wherein in one time slot, all of the at least one group is used.

3. The interference controlling method of the communication system according to claim 1, wherein in different time slots, the RRHs are classified by different ways.

4. The interference controlling method of the communication system according to claim 1, wherein in the performance table, one of the user equipments uses one of the antennas.

5. The interference controlling method of the communication system according to claim 1, wherein in the performance table, one of the user equipments uses more than one of the antennas.

6. The interference controlling method of the communication system according to claim 1, wherein amounts of the user equipments scheduled in different time slots are different.

7. A communication system, comprising:
at least two user equipments;
at least two remote radio heads (RRHs), wherein each of the RRHs is electrically connected to a plurality of antennas, and the communication system is used for the user equipments to communicate; and
a coordinator, comprising:
a scanning unit, used for operating measurement of a performance value of each of the antennas used for each of the user equipments by antenna sweeping, and obtaining a performance table according to the performance value of each of the plurality of antennas, wherein the performance table records an applicable relationship between each of the user equipments and the antennas or an applicable relationship between each of the user equipments and the RRHs, and the RRHs are classified into at least one group;
a storing unit, used for storing the performance table; and
a scheduling unit, used for scheduling the user equipments according to a priority information and the performance table,
wherein at least some of the user equipments using the same one of the at least one group are scheduled in different time slots to prevent from an interference.

8. The communication system according to claim 7, wherein in one time slot, all of the at least one group is used.

9. The communication system according to claim 7, wherein in different time slots, the RRHs are classified by different ways.

10. The communication system according to claim 7, wherein in the performance table, one of the user equipments uses one of the antennas.

11. The communication system according to claim 7, wherein in the performance table, one of the user equipments uses more than one of the antennas.

12. The communication system according to claim 7, wherein amounts of the user equipments scheduled in different time slots are different.

13. A coordinator, used for coordinating a communication system, wherein the communication system is used for at least two user equipments to communicate, and the coordinator comprises:
a scanning unit, used for operating measurement of a performance value of each of a plurality of antennas electrically connected to each of a plurality of remote radio heads (RRHs) for each of the user equipments by antenna sweeping, and obtaining a performance table according to the performance value of each of the plurality of antennas, wherein the performance table records an applicable relationship between each of the user equipments and the antennas or an applicable relationship between each of the user equipments and the RRHs, and the RRHs are classified into at least one group;
a storing unit, used for storing the performance table; and
a scheduling unit, used for scheduling the user equipments according to a priority information and the performance table,
wherein at least some of the user equipments using the same one of the at least one group are scheduled in different time slots to prevent from an interference.

14. The coordinator according to claim 13, wherein in one time slot, all of the at least one group is used.

15. The coordinator according to claim 13, wherein in different time slots, the RRHs are classified by different ways.

16. The coordinator according to claim 13, wherein in the performance table, one of the user equipments uses one of the antennas.

17. The coordinator according to claim 13, wherein in the performance table, one of the user equipments uses more than one of the antennas.

18. The coordinator according to claim 13, amounts of the user equipments scheduled in different time slots are different.
